(19) United States
(12) Patent Application Publication
(10) Pub. No.: US 2005/0103435 A1
(43) Pub. Date: May 19, 2005

(54) Methods of manufacturing airtight vessels, image displaying apparatuses and television sets

(75) Inventors: Masaki Tokioka, Kanagawa (JP); Mitsutoshi Hasegawa, Kanagawa (JP); Kazuo Koyanagi, Kanagawa (JP); Tokutaka Miura, Kanagawa (JP); Hiroharu Ueda, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/968,987

(22) Filed: Oct. 21, 2004

(30) Foreign Application Priority Data
Oct. 24, 2003 (JP) 2003-364027
Oct. 7, 2004 (JP) 2004-294471

(51) Int. Cl. B32B 31/00

(52) U.S. Cl. 156/292; 156/285

(57) ABSTRACT

The present application discloses a method of manufacturing airtight vessels having a step of arranging a first substrate and a second substrate opposite to each other in a standing state, and a step of bonding to one of the first substrate and the second substrate a frame for forming an airtight vessel together with the first substrate and the second substrate, wherein, at the bonding step, a seal bonding member airtightly bonded to the frame and with one of the substrates is formed by, after successively supplying a sealing material heated to a temperature not lower than the temperature at which the bonding is possible in a state in which the first substrate and the second substrate are arranged opposite each other, solidifying after that the sealing material to form a seal bonding member.

### BACKGROUND OF THE INVENTION

1. Field of the Invention

The present invention relates to a method of manufacturing airtight vessels, a method of manufacturing image displaying apparatuses using the airtight vessels, and a method of manufacturing television sets.

2. Related Background Art

Examples of the prior art related to airtight vessels for use in plane type image-forming apparatuses include what are disclosed in the Japanese Patent Application Laid-Open No. 2000-251654 and the Japanese Patent Application Laid-Open No. 2003-77396, both by the present applicants.

The Japanese Patent Application Laid-Open No. 2000-251654 discloses, as an invention pertaining to an airtight vessel, a procedure for “an airtight vessel having a pair of panels opposite each other, a supporting member for supporting the spacing between the panels, and an airtight seal-bonding portion for keeping the space between said panels airtight, to seal-bond said airtight seal-bonding portion with a metal having a low melting point” is disclosed, and a low cost and yet high grade airtight vessel and image-forming apparatus are realized by working out and improving a method of manufacturing using a metal having a low melting point, which was previously considered difficult to realize.

The Japanese Patent Application Laid-Open No. 2003-77396 discloses, as an invention pertaining to a method of manufacturing panel-shaped airtight vessels, a procedure in “a method of manufacturing panel-shaped airtight vessels to bring a pair of substrates constituting the front and rear faces of a panel-shaped airtight vessel and an external frame constituting circumferential side walls into a series of processing apparatuses having a plurality of depressurized processing chambers including at least a seal-bonding chamber, carry them successively through the processing spaces, and subject said pair of substrates and external frame having undergone prescribed processing to seal bonding in said seal-bonding chamber, wherein at least said pair of substrates are carried each in a standing state,” which makes it possible to reduce the installation area of the processing apparatuses.

These references have a common feature in disclosing a technique by which a supporting member (external frame) functioning as a spacer is perpendicularly fixed to one of the panels (one of the substrates), an end face of this supporting member is arranged opposite the other panel (the other substrate), and a material having a low melting point (a metal having a low melting point) is disposed in the gap between the frame and the substrates.

### SUMMARY OF THE INVENTION

Incidentally, whereas the present inventor is studying a method of fabricating an airtight vessel in a state in which the substrates are kept non-horizontal, he has found through this study that seal bonding in a state in which the substrates are kept non-horizontal gives only a poor yield. One of the specific reasons for the poor yield is the flow of the sealing material used for seal bonding.

An object of the invention is to enable airtight vessels to be formed with a high yield in a state in which the substrates are kept non-horizontal.

According to one aspect of the invention, there is provided a method of manufacturing airtight vessels having a step of arranging a first substrate and a second substrate opposite to each other in a standing state, and a step of bonding to one of the first substrate and the second substrate a frame for forming an airtight vessel together with the first substrate and the second substrate, wherein, at the bonding step, a seal bonding member airtightly bonded to the frame and with one of the substrates is formed by, after successively supplying a sealing material heated to a temperature not lower than the temperature at which the bonding is possible in a state in which the first substrate and the second substrate are arranged opposite each other, solidifying after that the sealing material to form a seal bonding member.

A particularly suitable configuration is one in which the bonding is accomplished while giving vibration to the sealing material.

According to another aspect of the invention, there is provided a method of manufacturing airtight vessels having a step of arranging a first substrate and a second substrate opposite to each other in a standing state, and a step of bonding to one of the first substrate and the second substrate a frame for forming an airtight vessel together with the first substrate and the second substrate, wherein, at the bonding step, a seal bonding member airtightly bonded to the frame and with one of the substrates is formed by forming the seal bonding member by solidifying a sealing material heated by local heating to a temperature not lower than the temperature at which the bonding is possible.

In local heating, the temperature in the position so far heated can be quickly reduced by stopping the heating or altering the heating position. In order to achieve quick temperature reduction, it is preferable to apply local heating in a condition where an area of a lower temperature than the temperature at which bonding is possible is formed in the vicinity of the position locally heated to a temperature not lower than the temperature at which bonding is possible.

Incidentally, the temperature at which bonding is possible means that at least bonding is possible at that temperature in an environment in which the bonding step is executed. For instance, where a metal is used as the sealing material, if the metal is melted in a condition where bonding is possible is achieved, and accordingly at or above the melting point of the metal there is a condition where heating to or above a temperature permitting seal bonding is reached.

As a configuration for local heating to or above a temperature at which a sealing material can be bonded, there can be a combination of prescribed heating means for local heating and another heating means which can heat more evenly a broader range than the heating by the prescribed heating means for example, heating by the prescribed heating means and heating by the other heating means being combined to heat the sealing material to a temperature to or above the temperature permitting seal bonding. In a position where the temperature raising by the prescribed heating means is lower than the bonding material, quick cooling can be made possible by the lower temperature of the sealing material than the temperature at which bonding is possible.

It is preferable according to the invention for the local heating to be applied to a small area at a time so that a closed bonding line to be formed by the seal bonding member be formed portion by portion. It is also preferable to use irradiation with light for the local heating. By applying local heating to a small area at a time, the bonding line is formed portion by portion. Application to a small area at a time may also mean consecutive variation of the position to be bonded. A configuration in which the small area to be bonded is successively varied along the planned positions of bonding line formation would be preferable, but this is not the only preferable configuration.

According to each of the aspects of the invention described above, it is preferable to accomplish the bonding step in a vacuum ambience. In a configuration in which the bonding step is accomplished after butting the frame and one of the substrates against each other, it is preferable also to perform this butting step in a vacuum ambience. Whereas a vacuum ambience in this context means an ambience reduced in pressure to a lower level than in the ambience around, in fabricating an airtight vessel having an electron-emitting device inside, it is preferably an ambience of a pressure not higher than 1×10⁻³ Pa. Where an airtight vessel in which any desired gas is sealed is to be fabricated, it is preferable to accomplish the bonding step or the butting step in an ambience containing that gas.

According to each of the aspects of the invention described above, it is preferable to execute the bonding step in a state in which the frame and one of the substrates are butted against each other.

According to each of the aspects of the invention described above, it is preferable to dispose the sealing material in a corner formed by butting of the frame and one of the substrates or another corner to be formed by the execution of that butting. The step of disposing the sealing material in the corner formed by butting of the substrate and the frame and or another corner to be formed by the execution of that butting, if it is the step of disposing the sealing material in the corner formed by butting of the substrate and the frame, would be accomplished after the butting step or, if it is the step of supplying the corner to be formed by the execution of that butting, would be accomplished before the butting step. However, because supplying the sealing material after forming a corner would facilitate supply positioning in supplying the sealing material, the configuration in which the sealing material is supplied after the formation of the corner is more preferable.

As the substrates in this context can be selected from various alternative configurations. Preferably, glass substrates can be used. It is also possible to use plates whose base is coated with a prescribed film, such as an insulating film. Or plates on whose base wiring or some other prescribed member is formed can be used as well. Where substrates on whose base a prescribed film or a prescribed member is formed are to be used, at the step of butting the frame in which the airtight space is to be partitioned, the frame in which the airtight space is to be partitioned may be butted against the prescribed film or the prescribed member. Especially where substrates over which wiring or some other electrodes are formed are to be used, if the wiring is also arranged over the bond-sealed part, the seal bonding member can be prevented from becoming electrically continuous to the electrodes by providing an insulator, such as an insulating film, over the electrodes even if the seal bonding member is a conductor.

To add, after the step of supplying the sealing material, the freedom of selecting the form of supplying the sealing material can be increased by performing the step of local heating to or above the temperature at which bonding is possible. This is particularly preferable because it permits the use of a molded sealing material in a solid state.

According to each of the aspects of the invention described above, it is preferable to configure the seal bonding member so as to constitute a closed bonding line.

According to each of the aspects of the invention described above, as the bonding step, it is preferable to adopt a step to cause the seal bonding member to constitute a closed bonding line in a state in which the frame and the other of the substrates are butted against each other, and for a section of the seal bonding member cut in a prescribed position on the bonding line in a direction orthogonal to the lengthwise direction of the bonding line to have a shape in which the length of contact with the frame is longer than the length of penetration between the opposite faces of the substrate and the frame in the corner composed of the substrate and the frame by the butting. It is particularly preferable for the penetration depth to be 0.

It is preferable for the sealing material to be a substance having a low melting point. The substance having a low melting point in this context is a substance whose melting point or softening point is no higher than 300° C. Glass, a typical one the common materials for airtight vessels allows metal atoms, especially silver and lead atoms to easily diffuse in a high temperature ambience, and the progress of diffusion of metal atoms may considerably affect the performance of an electronic device formed or to be formed in the vessel. Especially at a high temperature above 300° C., the diffusion is known to progress in proportion of the lapse of time. The use of a substance whose melting point or softening point is no higher than 300° C., such as metal In, its alloys or soldering materials including PbSn can restrain hysteretic temperature.

It is preferable in the butted state that there is a scarf portion, which is a portion whose shape is machined to facilitate satisfactory seal bonding by the sealing material in the corner. The machining should preferably precede the butting.

It is preferable to adopt a configuration in which a material having good wettability with the sealing material is formed as a base film in the region where the sealing material is disposed. A material having good wettability with the sealing material here means a material the wettability of which as the base film with the sealing material is better than the wettability between the sealing material and the face on which the sealing material is disposed in a state in which no base material consisting of this material is formed. A configuration in which the sealing material is indirectly heated and melted by heating this base film can also be suitably adopted.

Incidentally at the bonding step, it is preferable to bond in advance the other substrate, which is not the substrate to be bonded with the seal bonding member, and the frame. It is also possible to use a product in which the other substrate and the frame are integrally formed, instead of using separate items. In that case, the part of that integrally fabricated product opposite the first mentioned substrate constitutes the other substrate and the part functioning as a frame constitutes the frame as such.

The standing state in the context of the present application means that the normal at the center of gravity of the main face of each substrate (the center of gravity of the largest face) is not parallel to the vertical line, but preferably the angle formed by the normal and the vertical line (the smaller of the angles formed by the normal and the vertical line) should be no less than 45 degrees. It is more preferable for the angle to be no less than 60 degrees, and even more preferable for the angle to be no less than 80 degrees.

The invention also relates to a method of manufacturing of image displaying apparatuses, and includes methods of manufacturing of forming image displaying apparatuses whose airtight vessel containing a display device is formed by a method according to any one of the first through 10th aspects of the invention. Suitably usable display devices include electron-emitting devices, such as surface conduction electron-emitting devices and electro-luminescence devices.

The present application also covers a method of manufacturing television sets. More specifically, the method of manufacturing television sets has a step of connecting an airtight vessel fabricated by the method of manufacturing under this application and a drive circuit for applying a voltage to display electrodes within the airtight vessel and a step of arranging a controller for displaying television images. For instance in a configuration display devices arranged in a matrix form are provided in the airtight vessel, at least some of the plurality of wirings constituting the matrix wiring can be cited as the aforementioned display electrodes. Or, for instance in a configuration in which electrodes for applying potentials to accelerate electrons are disposed in the airtight vessel, the electrodes can be cited as the display electrodes in this context.

### BRIEF DESCRIPTION OF THE DRAWINGS

FIGS. 1A and 1B illustrate a method of manufacturing airtight vessels pertaining to one aspect of the present invention and a method of manufacturing an airtight vessel, which is a first preferred embodiment of the invention;

FIG. 2 illustrates on an enlarged scale the seal bonding portion in the method of manufacturing of airtight vessels shown in FIGS. 1A and 1B;

FIG. 3 illustrates on an enlarged scale the state in the vicinity of a base film, where one is formed, in the method of manufacturing of airtight vessels shown in FIGS. 1A and 1B;

FIG. 4 illustrates on an enlarged scale the state in the vicinity of a scarf portion, where one is formed, in the method of manufacturing of airtight vessels shown in FIGS. 1A and 1B;

FIGS. 5A and 5B comprise a schematic diagram of processing chambers for carrying out a series of steps and a graph showing the temperature profiles in the processing chambers;

FIGS. 6A, 6B and 6C illustrate a method of manufacturing an airtight vessel, which is a second embodiment of the invention;

FIG. 7 illustrates the local heating step for the second embodiment;

FIGS. 8A and 8B illustrate the relationship between the penetration length Q2 of sealing material into a rear plate (substrate) and a glass outer frame (between frames) and the contact length Q1 between the frame and a seal bonding member;

FIG. 9 shows a partially cut perspective view of an image displaying apparatus that can be fabricated according to the invention; and

FIG. 10 shows a top view of a television set that can be fabricated according to the invention.

### DESCRIPTION OF THE PREFERRED EMBODIMENTS

Whereas the best mode for carrying out the present invention will be described below with reference to the accompanying drawings, the invention is in no way limited to this mode.

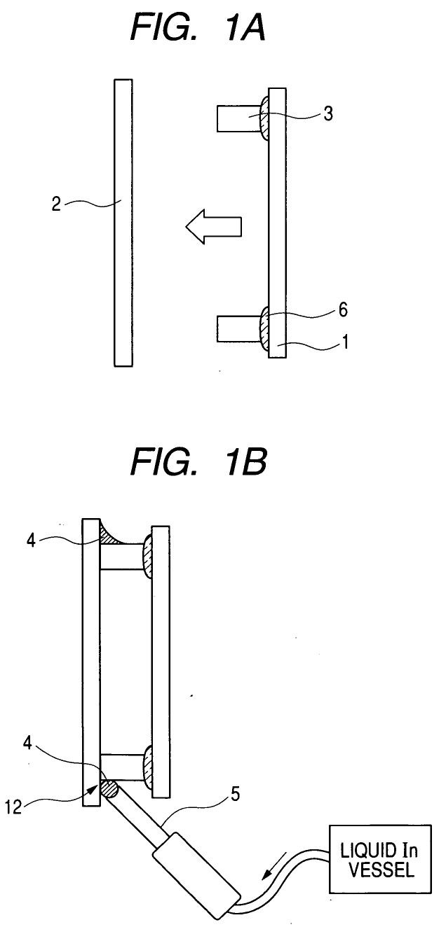

FIGS. 1A and 1B illustrate an example of method of manufacturing airtight vessels pertaining to the invention. In this example, the following sequence of steps is accomplished in a vacuum chamber at a vacuum ambience of, for instance, 1×10⁻⁵ Pa or below.

(Assembling Step)

FIG. 1A shows the assembling step, at which an end face of a laterally fixed outer frame of one substrate out of a pair of substrates, positioned opposite each other in a standing state, is butted against the other substrate in the vacuum ambience to form a corner (recessed corner) 12. In this example, the pair of substrates standing opposite each other in a state of standing in the vertical direction are a rear plate 2 and a face plate 1 constituting an image-forming apparatus, a glass outer frame 3, which is the frame, is laterally bonded and fixed to the face plate 1 in the horizontal direction by using frit glass 6 (i.e. the glass outer frame 3 is perpendicularly fixed to the face plate 1), and an end face of this glass outer frame 3 is horizontally butted against the rear plate 2, which is the other substrate, to form the corner 12.

(Seal Bonding Step)

FIG. 1B shows the sealing material arranging step, at which sealing material is disposed in the corner 12 formed by horizontally butting the end face of the glass outer frame 3 against the rear plate 2 standing in the vertical direction.

The corner 12 is a part enclosed by two faces unparallel to each other. Here, it is the part formed by butting the end face of the glass outer frame 3 against the rear plate 2, and is a corner enclosed by the top face of the rear plate 2 and a side face of the glass outer frame 3, which is unparallel to that top face. As corners are also formed inside an airtight space partitioned by the face plate 1, the rear plate 2 and the glass outer frame 3, and any of these corners can be used as the part in which the sealing material is to be arranged, but in the configuration adopted for this embodiment the sealing material is disposed in a corner outside the airtight space with a view to the ease of executing the bonding step.

It is preferable to use a substance having a low melting point as the sealing material to be disposed in this corner 12. In this example, indium (In) is used as a metal having a low melting point. The melting point of In is relatively low, 156° C., and discharges little gas at its melting point (softening point). Where frit glass is used, heating to around 500° C. is required, but heating to 200° C. is sufficient for In, and this is an advantage in process simplification. Known substances having a low melting point include not only pure indium but also indium alloys, which can also be used suitably.

Instead of executing the series of steps in a vacuum ambience, it is also possible to provide an exhaust port (not shown) in some position of the airtight vessel to be fabricated and, after discharging the air inside the airtight vessel through the exhaust port to form a vacuum ambience, seal the exhaust port. In this example, however, In is used as the sealing material, and this In is oxidized in the atmosphere with relative ease, and therefore it is desirable to execute the steps in a vacuum ambience as in this example. This is because melting metal In in the atmosphere would invite formation of a thick surface oxide film and, as indium oxide is harder than pure In, it might adversely affect airtightness. As the ambience might also have an adverse effect where some other sealing material, such as an indium alloy, some other pure metal or ally is used, it is desirable for the heating step for bonding to be executed in a vacuum ambience.

The In used in this example is liquid metal In4 in a molten state. As illustrated, it is supplied from a liquid In vessel to the heating portion of local heating means, and supplied to the whole circumference of the corner 12. The supply of liquid metal In4 in a molten state is accomplished by delivery with a gear pump, rotary pump or the like. Liquid metal In4 in a molten state can as well be applied by using a constant quantity-delivering type dispenser. Since delivery in a constant quantity is difficult with a common pneumatically controlled dispenser, it is preferable to use a dispenser having a cylinder or gear type delivery mechanism. It is also conceivable to use metal In4 in a solid state, molded into a wire rod, as the sealing material and arrange it to form a loop all around the corner 12.

Where liquid metal In4 in a molten state is to be disposed in the corner 12 as in this example, the supply of the sealing material and local heating are accomplished at the same time, but in the case of disposing metal In4 in a wire rod shape in the corner 12, this metal In4 in a wire rod shape is melted by local heating with local heating means in a small area at a time and thereby melted.

In this example, an ultrasonic soldering iron 5, which is ultrasonic heating means, is used as the local heating means. By using this ultrasonic soldering iron 5, ultrasonic vibration is applied to the melt bonding region, thereby enabling In to be melt deposited with a strong adhering force. The ultrasonic heating means is not the only available means of local heating, but heating can be achieved in any of many other applicable forms. For instance, the metal can be irradiated with light, for instance by using a semiconductor laser. Heating means using radiant heat or electromagnetic wave is also applicable.

The ultrasonic soldering iron 5 is equipped with a mechanism for automatically feeding liquid metal In4 in a molten state to the tip (heating portion) of the iron, so that soldering can be accomplished by merely moving the ultrasonic soldering iron 5 along the corner 12. Thus, liquid metal In4 can be disposed with a strong adhering force by being fed from the liquid In vessel, vibrated by the tip of the ultrasonic soldering iron 5, and melt deposited on the outside of the corner 12.

Where the ultrasonic soldering iron 5 as in this example, as liquid metal In4 is locally applied to the corner 12 and the local heating means is successively shifted, the liquid metal is successively cooled and solidifies after the melt bonding. Seal bonding here is accomplished under such conditions as can restrain faulty seal bonding due to the flow of liquid metal In even if it is accomplished in a state in which the substrates are stood upright. The conditions comprise the temperature and shifting speed of the ultrasonic soldering iron 5, which determine the In film thickness, the feed volume of liquid metal In4, the substrate temperature and the ultrasonic power to vibrate the tip of the ultrasonic soldering iron 5. These conditions are set within a range in which only fluidity can be given to the liquid metal In4 but no faulty melt bonding may result. Since the temperature here is set not to a level higher than the temperature at which the whole of the face plate 1, the rear plate 2 and the glass outer frame 3 can be bonded, but the configuration is such that any area heated to a temperature above the temperature at which bonding is possible can be quickly cooled, this temperature condition can be easily satisfied. Thus, since the fed sealing material rapidly solidifies without being deprived of heat by the surroundings, the flow of the sealing material can be restrained. In particular, as the configuration is such that seal bonding is accomplished in the corner so that seal bonding can be achieved without having to let the sealing material penetrate into the gap between the frame and the substrates, the requirement for strict observance of such conditions as the temperature control and the speed control of the local heating means is eased. In order to make possible seal bonding in the corner without having to let the sealing material penetrate into the gap between the frame and the substrates, the supply quantity of the sealing material and the pressure under which the substrates and the frame are butted against each other can be controlled.

This example is simplified by accomplishing the arrangement of the sealing material and local heating as a single step, it is also possible to divide the arrangement of the sealing material and local heating into separate steps and, after disposing the wire rod-shaped sealing material in the corner 12, and cause the sealing material to be melted by the local heating means. In this case, as means of disposing the wire rod-shaped sealing material in the corner 12, for instance a triaxial robot is used. Another alternative is to have the sealing material melted by the local heating means while feeding it out from the sealing material means into the corner 12. A conceivable configuration is to equip the triaxial robot for disposing the metal In4 with the ultrasonic soldering iron. Another conceivable configuration is to provide the local heating means itself with a function to feed the wire rod-shaped sealing material and, while feeding out the sealing material from the local heating means, feed the material to the heating unit of the means to dispose the material in the corner 12. For example, the tip of the triaxial robot can be provided with both a material applying head and a soldering iron head, so that the shifting mechanism and some other functions can be shared.

As the melt deposited portion of the liquid metal In4 disposed by the local heating means begins to be cooled and solidify successively by successively shifting the local heating means, the length of cooling time can be substantially reduced.

Whereas seal bonding is accomplished by successively shifting in this way the local heating means along the outer circumference of the airtight vessel, if the device is configured of a plurality of local heating means, it will be possible to carry out melt bonding in a plurality of positions at the same time, seal bonding can be accomplished in an even shorter period of time. Where there is used heating means which does not require bringing the heating energy source and the heating position close to each other unlike the local heating means which accomplishes heating by irradiation with a laser beam, it is not necessary to shift the local heating means along the position in which the bonding line is to be formed, but an arrangement which allows successive changing of the irradiating position would suffice, resulting a simplified device configuration.

In the process so far described, the airtight vessel is completed in a state in which the rear plate 2 and the face plate 1 are kept standing, and the whole circumference of the corner 12 between the rear plate 2 and the glass outer frame 3 is seal bonded with metal In4.

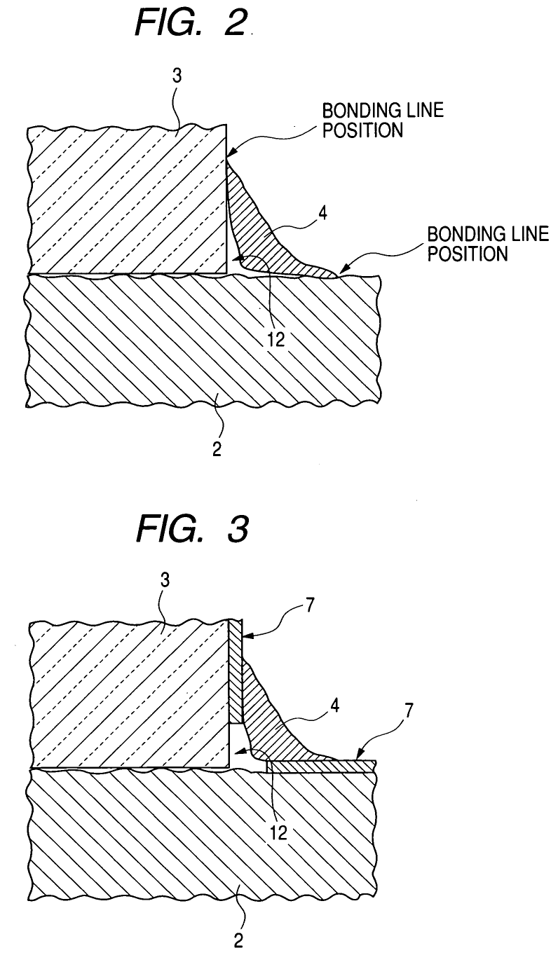

FIG. 2 illustrates on an enlarged scale the state of the seal bonding portion.

As illustrated therein, even where the end face of the glass outer frame 3 is brought closest to the rear plate 2, their meeting face is not flat microscopically but has unevenness on the surface, which makes it difficult to claim its complete alignment. The conceivable reason for the surface unevenness includes the unevenness of the electrodes and wiring patterns formed over the rear plate 2. The glass outer frame 3 and the rear plate 2 are pressed together with only a little pressure, not substantially greater than its own weight, and are so fixed that their relative positions do not change before and after the melt bonding of metal In4.

The metal In4 locally melt deposited by the ultrasonic soldering iron 5 is bonded with the rear plate 2 and the glass outer frame 3 not in the region where they are in direct contact with each other (between parallel faces opposite each other) but in its vicinity, and the airtight vessel is thereby formed. The seal bonding member, which is the hardened sealing material, constitutes the bonding line. This bonding line is formed all around the outer circumference of the glass frame 3 to constitute a closed loop.

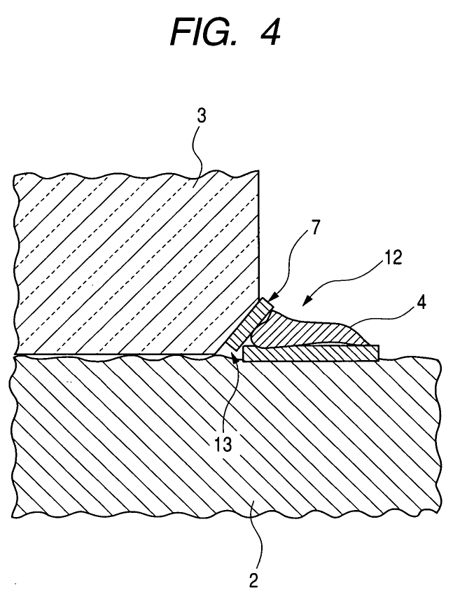

Also, it is also possible to form, as shown in FIG. 3, a base film 7 of a material having high wettability with the sealing material in a region where liquid metal In4 as the sealing material is to be disposed. It is preferable for this base film 7 to be formed in the respective bonding line positions of the rear plate 2 and the glass outer frame 3.

As the material of the base film 7, one of such precious metals as Au, Ag and Pt, which are highly solderable and chemically stable is used, formed in a thickness of a few am. The available methods of forming the base film 7 include, for instance, printing and baking a paste-like material with a binder mixed into it, in addition to plating and vapor deposition, and the choice is not limited to any of them.

Where the base film 7 is to be formed as stated above, the sealing material can as well be indirectly heated and melted by heating the base film 7. Especially where light irradiating means, such as a semiconductor laser, is to be used as the local heating means, it is desirable and suitable to provide a base film because no ultrasonic vibration is generated unlike where ultrasonic heating means is used.

Further, in order to secure airtightness even with a small quantity of metal In4, the configuration shown in FIG. 4 can be effectively used. Thus, since the glass outer frame 3 requires only a single function for forming an airtight vessel, there will be no problem if the end face of the glass outer frame 3 is chamfered to form a scarf portion 13 as shown in FIG. 4. In this case again, if the base film 7 is formed within the scarf portion 13, the molten metal In4 will spread by virtue of its wettability with the base film 7, enter into the gap between the rear plate 2, which is the scarf portion 13, and the glass outer frame 3 to enable even a small quantity of metal In4 to secure sufficient airtightness.

In the context of the present invention, the bonding step described above is a step of so forming the seal bonding member as to constitute a closed bonding line in a state in which the frame and the aforementioned other substrate are butted against each other. The section of the seal bonding member cut in a prescribed position on the bonding line in a direction orthogonal to the lengthwise direction of the bonding line should preferably have, in the corner formed by the substrate and the frame by the butting, a shape in which the length of contact with the frame is longer than the length of penetration between the opposite faces of the substrate and the frame. A particularly preferable penetration length is 0.

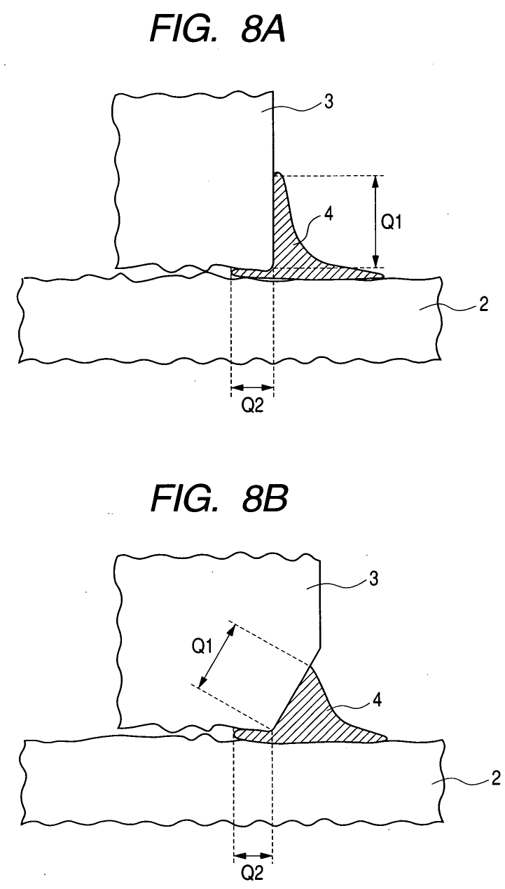

The configuration described above is shown in FIGS. 8A and 8B. Referring to FIGS. 8A and 8B, the sealing material has penetrated into and solidified in the mutually parallel opposite faces of the rear plate 2 (substrate) and the glass outer frame 3 (frame). That penetration length is represented by Q2, and the contact length between the glass outer frame 3 and the seal bonding member, by Q1. It is preferable for Q1 to be greater than Q2, and particularly preferable for Q2 to be 0. In order to meet this condition, the step of feeding the sealing material should be executed under such conditions as enable Q1>Q2 to be realized in the seal bonding member to be formed by the subsequent solidification of the sealing material. More specifically, this can be realized by properly controlling the quantity of the sealing material to be fed. Alternatively, Q1>Q2 can also be realized by controlling the butting pressure between the rear plate 2 (substrate) and the glass outer frame 3 (member).

Thus by the method of manufacturing airtight vessels in this example, a pair of substrates opposite each other in a standing state are held with a prescribed space between them, and the sealing material for forming the bonding line is successively melt deposited in a small area at the time by shifting the local heating means without changing the relative positions of the two substrates before and after the seal bonding. Therefore, as there is no need to uniformly press the whole substrates or to keep the temperature uniform, a highly reliable airtight vessel can be realized in a small space and by an inexpensive process.

Furthermore, since the airtightness of the airtight vessel can be secured even if the surface of the rear plate 2 is uneven, it can be effectively applied to the fabrication of an image displaying apparatus in which a phosphor and an electron accelerating electrode are formed over the face plate 1 and an electron source is formed over the rear plate 2. Incidentally, it is preferable to use a surface conduction electron-emitting device as this electron source. To add, the invention under the present application can be used for bonding the face plate and the outer frame. There are a great variety of available display devices besides the electron-emitting device, including an electro-luminescence device.

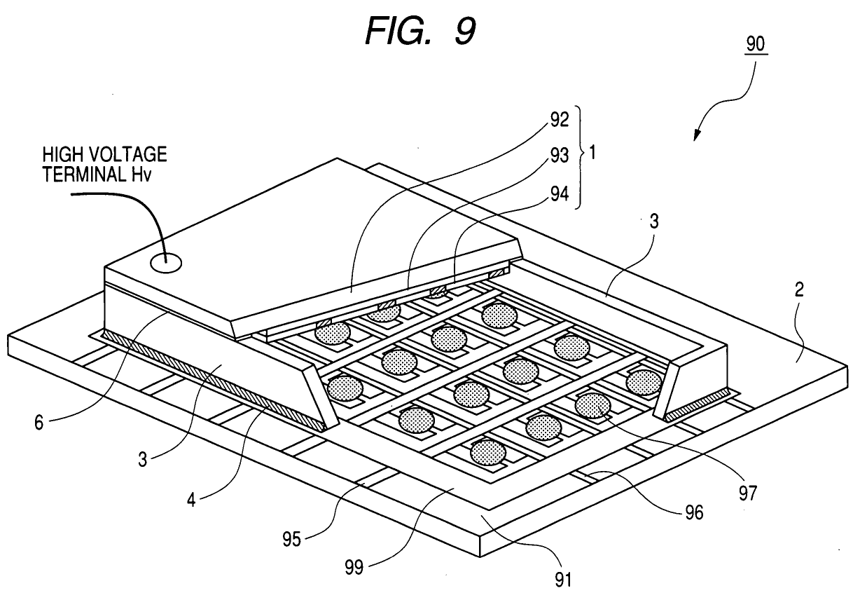

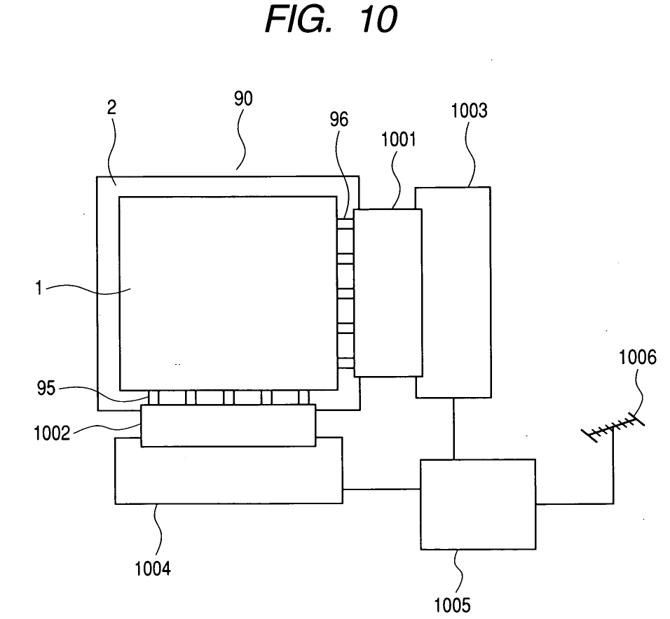

FIG. 9 shows an example of image displaying apparatus according to the present invention. Over an electron source substrate 91 disposed on the rear plate 2 side, X wirings 95 and Y wirings 96 are formed in a matrix form, and electron-emitting devices 97 are provided, connected to the X wirings 95 and the Y wirings 96 and each matching one pixel or another. The glass outer frame 3 and the face plate 1 are bonded by the frit glass 6, and the glass outer frame 3 and the rear plate 2 are bonded in the corner by metal In. On the inner face side of the face plate 1 are provided a fluorescent film 93 and a glass substrate 92 having a metal back 94 to cover the surface of the fluorescent film 93. The metal back 94 is supplied with a voltage from a high voltage terminal Hv. The face plate 1, the rear plate 2 and the glass outer frame 3 constitute an envelope 90, which is an airtight vessel whose inner space is kept in a vacuum ambience. The X wirings 95, the Y wirings 96 and the metal back 94 are display electrodes, and in particular over the X wirings 95 and the Y wirings 96, there is disposed an insulator 99 to avoid electrical conduction between In to constitute seal bonding member on the one hand and the X wirings 95 and the Y wirings 96 on the other. The insulator 99 is formed by applying a dielectric paste containing PbO glass particulates and baking it.

### EMBODIMENTS

Whereas the preferred embodiments of the present invention will be described below with reference to the accompanying drawings, the invention is in no way limited to these embodiments.

### Embodiment 1

The method of manufacturing the airtight vessel, which is Embodiment 1, will be described below with reference to FIGS. 1A and 1B. In this embodiment, the following sequence of steps will be executed in a vacuum chamber set to a high vacuum ambience of no more than 1×10⁻⁵ Pa.

(Step 1-a)

Referring to FIGS. 1A and 1B, step 1-a represents the assembling step. The face plate 1 and the rear plate 2 are a pair of substrates opposite each other in a state of standing in the vertical direction. In this embodiment, the face plate 1 is a glass substrate over which a phosphor and an accelerating electrode for accelerating electrons emitted from an electron source are formed, and the rear plate 2 is an electron source substrate. The height of the glass outer frame 3 between these substrates 1 and 2 determines the space between them.

First, after bonding the glass outer frame 3 in a standing state over the face plate 1 and fixing it there by using the frit glass 6, this face plate 1 is stood in the vertical direction, and the end face of the glass outer frame 3 is horizontally butted against the rear plate 2 standing in the vertical direction to form the corner 12.

The face plate 1 and the rear plate 2 are aligned in position with high precision. Where the airtight vessel of this embodiment is to be used in a flat panel color display, the alignment is accomplished within a tolerance of about 50 μm. The fixing pressure applied in the assembling process need not be stronger than equivalent to the weight of the face plate 1 and the glass outer frame 3 themselves. Therefore, no elaborate pressing means is required.

According to the conventional method of manufacturing, a prescribed pressure should be uniformly applied because frit glass, which is the sealing material, sets off the surface unevenness of the glass substrate to secure airtightness. For this reason, a highly precise mechanism for uniform application of pressure is required, or feedback control over positional deviations ensuing from the deformation of substrates is needed, necessitating a large manufacturing apparatus, which entails an extra production cost. The present invention, however, requires no heavy pressure or no particular care for uniformity, and yet providing an advantage of a higher yield. As the substrates are arranged in a standing state, warping or deformation otherwise of substrates due to their own weight can be restrained. This also facilitates positional alignment. From the viewpoint of restraining the deformation of substrates or limiting the installation space of equipment for seal bonding, it is preferable for the standing state of substrates to be such that the angle formed between the normal of the substrates and the vertical line is no less than 45 degrees, more preferable to be no less than 60 degrees, and still more preferable to be no less than 80 degrees. In this embodiment, the angle is set to 90 degrees.

(Step 1-b)

Referring to FIGS. 1A and 1B, step 1-b represents the seal bonding step. In this embodiment, liquid metal In4 in a molten state is used as the sealing material. The liquid metal In4 is disposed in the corner 12 formed by horizontally butting the glass outer frame 3 over the rear plate 2 stood in the vertical direction. In this embodiment, liquid metal In4 stored in the liquid In vessel is automatically fed to the tip of the ultrasonic soldering iron 5 with a gear pump. The liquid metal In fed to the tip of the ultrasonic soldering iron 5 is disposed in the corner 12 with a high adhering force by being supersonically vibrated. The ultrasonic soldering iron 5 is caused to scan the four sides of the outer circumference of the airtight vessel by a triaxial robot, and a bonding line is formed all around the circumference of the corner 12 in a closed loop.

As described above, metal In is readily oxidized in the atmosphere even at a room temperature, and forms a hard surface oxide film over the surface. The melting point of the In surface oxide film is high, 0.800° C. or even more. As the In surface oxide film is not melted when heated but remains as a solid in liquid In, it may form a leak path, which would invite a vacuum leak. Therefore, some heating means that can actively break the surface oxide film is desirable. If the In surface oxide film is broken, liquid In will ooze out from inside and convect, and its chemical reaction with pure In will vaporize the oxide, resulting in an alleviated fear of leaking. In order to break the oxide film and cause metal In4 to be bonded to the glass surfaces of the rear plate 2 and the glass outer frame 3 to ensure a high level of airtightness, it is desirable to use ultrasonic soldering. The capability of the ultrasonic soldering iron 5 will be sufficient if it can develop ultrasonic power of a few watts at an iron temperature of 200° C. or more.

In this embodiment, as shown in FIG. 2, when melt bonding the metal In4 with the rear plate 2 or the metal In4 with the outer frame 3 in the position of the bonding line of the corner 12, the ultrasonic soldering iron 5 is successively shifted along the whole circumference of the corner 12 to locally melt the metal In4 and seal bond it. In this way, the rear plate and the frame are bonded to each other via the seal bonding member in the corner formed by butting.

The configuration in which the sealing material is disposed in the gap between the rear plate and the end face of the glass outer frame and seal bonding is accomplished mainly in that gap portion, uniform heating all around the circumference is required. In order to heat a glass substrate of a few tens of centimeters square within a uniformity tolerance of about ±4° C., about 20 heater segments should be individually controlled, necessitating the use of an expensive and large temperature control apparatus. By contrast, this embodiment can accomplish seal bonding with no problem even if there is a temperature distribution of 10° C. or even more, and moreover the seal bonding can be accomplished easily.

Moreover, since liquid metal In4 in a molten state is locally disposed outside the corner 12 and the local heating means is successively shifted, cooling and solidification take place successively after the melt bonding, but the seal bonding is accomplished in such conditions that the flow of liquid metal In poses no problem even though it is performed in a state of keeping the substrates standing (perpendicular state). The conditions comprise the temperature and shifting speed of the ultrasonic soldering iron 5, which determine the In film thickness, the feed volume of liquid metal In4, the substrate temperature and the ultrasonic power to vibrate the tip of the ultrasonic soldering iron 5. These conditions are set within a range in which only fluidity can be given to the liquid metal In4 but no faulty melt bonding may result.

Further, in order to strengthen the adherence between the liquid metal In4 and the glass surface of the glass outer frame 3, it is desirable to form the base film 7 for improve properties of affinity including wettability over the glass surface as shown in FIG. 3. As stated above, as the material of the base film 7, one of such precious metals as Au, Ag and Pt, which are highly solderable and chemically stable is used, formed in a thickness of a few am. The available methods of forming the base film 7 include, for instance, printing and baking a paste-like material with a binder mixed into it, in addition to plating and vapor deposition.

This embodiment has allowed successful fabrication of a low-cost and yet highly reliable airtight vessel. The airtightness of the airtight vessel is so high that the leak quantity of He gas is no more than 1×10⁻¹⁴ Pa·m³/sec. Application of this airtight vessel to a flat panel display having a surface conduction electron-emitting source would give a reliable high grade display whose service life can be ensured for 10,000 hours or even more.

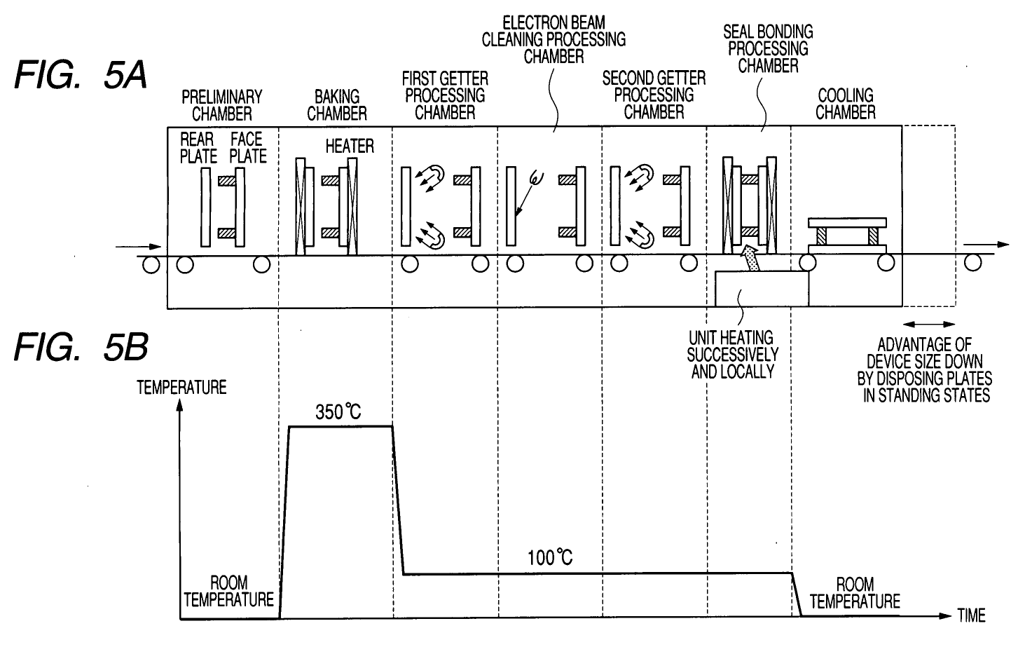

Next will be described a fabricating apparatus for the manufacture of flat panel displays by the method of manufacturing airtight vessels of this embodiment with reference to FIGS. 5A and 5B. Referring to FIGS. 5A and 5B, FIG. 5A schematically shows processing chambers for executing a sequence of steps, where the horizontal axis represents time, while FIG. 5B shows a temperature profile, where the horizontal axis represents time and the vertical axis, the process temperature. FIG. 5A shows, from left to right, a preliminary chamber, a baking chamber, a first getter processing chamber, an electron beam cleaning processing chamber, a second getter processing chamber, a seal bonding processing chamber and a cooling chamber. Incidentally in this embodiment, with a view to faster bake processing, the bake processing is executed at 350° C. While the face plate 1 (the other substrate) and the glass outer frame 3, which is the frame, are bonded with frit glass to ensure enduring this temperature, it is also made possible by the execution of this bake process at a lower temperature (e.g. 100° C.) to use a configuration in which the face plate 1 and the glass outer frame 3 are bonded together in advance with a metal having a low melting point, such as In.

As this embodiment handles the substrates in a standing state (perpendicular state) within the apparatus, there is no need for an electrostatic chuck or a like mechanism, but a small and yet efficient heating arrangement can be used, such as lamp heating in a vacuum ambience. Though the shifting stroke of the substrates is unchanged from the conventional method, they need to be shifted only laterally to assemble and fix the substrates, even a simple motor would suffice if used in combination with a shifting guide or the like. Furthermore, since seal bonding is accomplished by local heating, the temperature in the seal bonding chamber can be relatively low, and the process can be shortened because fewer heating cycles are involved than in the conventional process.

Furthermore, the handling of the substrates in a standing state (perpendicular state) permits the use of smaller and less expensive means for supporting, shifting and heating the substrates. The larger the image displaying apparatus to be fabricated, the greater this advantage.

### Embodiment 2

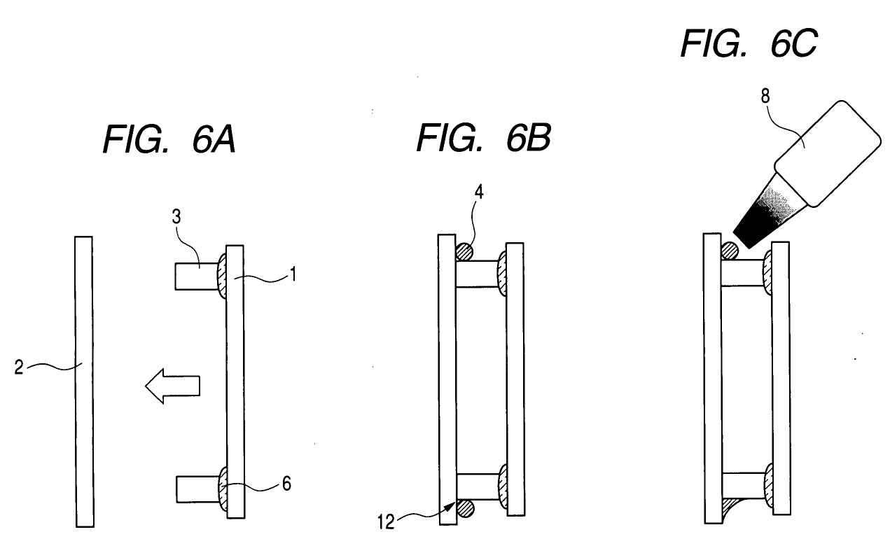

With a view to reducing the hardware size, Embodiment 2 uses a semiconductor laser as the local heating means, and the arrangement of the sealing material and local heating are accomplished at separate steps. Whereas the method of manufacturing of the airtight vessel of Embodiment 2 will be described below with reference to FIGS. 6A to 6C, step 6-a will be executed in the same way as step 1-a for Embodiment 1.

(Step 6-b)

Referring to FIGS. 6A to 6C, step 6-b represents the sealing material arranging step, at which metal In4 molded into a wire rod is disposed in the corner 12 formed by the rear plate 2 and the glass outer frame 3. In this embodiment, metal In4 in a wire rod shape of 1 mmφ is disposed outside the corner 12 by using a triaxial robot.

(Step 4-c)

Referring to FIGS. 6A to 6C, step 4-c represents the local heating step. In this embodiment, a semiconductor laser 8 of about 800 nm in wavelength is used as the local heating means. This semiconductor laser 8 condenses a beam of about 10 W in power to about 1 mmφ with a condensing lens (not shown), and irradiates metal In4 with the condensed beam. Since such heating by light condensation with the semiconductor laser 8 permits the use of smaller local heating means than where the ultrasonic soldering iron is used as in Embodiment 1, seal bonding can be readily accomplished even where a thin airtight vessel whose glass outer frame 3 is less than 2 mm in height is to be fabricated.

If an optical guide, such as an optical fiber, is used on the route to the light condensing lens, the heating means can be reduced in size and assembly facilitated. Other available light irradiating means include a xenon lamp, in addition to a semiconductor laser.

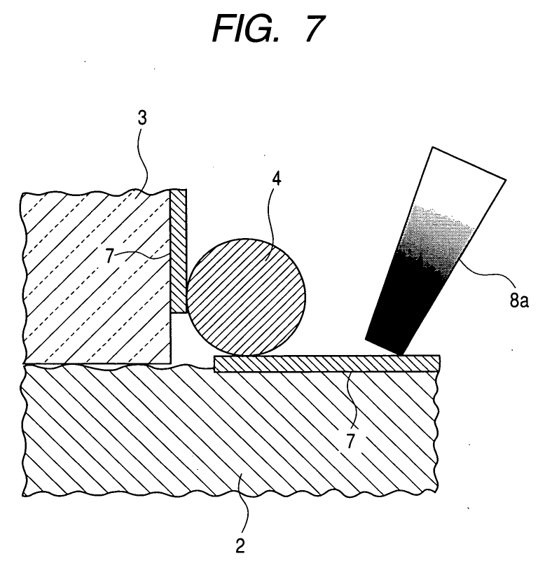

Further in this embodiment, in the region where metal In4 as the sealing material is to be disposed, the base films 7 of a material having good wettability with the sealing material are formed as shown in FIG. 7. More specifically, the base films 7 are formed in the respective bonding positions of the rear plate 2 and the glass outer frame 3 with the sealing material.

The presence of these base films 7 provides the following two advantages. First, in this embodiment which uses the semiconductor laser 8 as heating means, there is the advantage that satisfactory bonding can be achieved while securing sufficient wettability with the glass surface even without the assistance of ultrasonic vibration or the like.

The other advantage is that, as metal In4, which is a sealing material having metallic gloss, is used, reflection of light by the sealing material reduces the heating efficiency, but at least part of this lost efficiency can be compensated for with heat emission by light absorption by the base layer. In order to enhance this advantage, it is desirable to indirectly heat metal In4 by irradiating the base film 7 with a laser beam 8a as shown in FIG. 7 instead of directly irradiating metal In4 with light. Where silver paste, which is the wiring material for electron-emitting devices, is used as the base film 7, a film with surface unevenness can be realized, which is a metal film having no metallic gloss with an energy absorption rate of more than 50%, resulting in particular effectiveness.

In order to secure airtightness even with a small quantity of metal In4, it is desirable to form the scarf portion 13 by chamfering the end face of the glass outer frame 3 as shown in FIG. 7. In this case again, by forming the base film 7 within the scarf portion 13, heated and melted metal In4 will spread by virtue of its good wettability with the base film 7 as described above, enter into the gap between the rear plate 2 and the glass outer frame 3, which constitutes the scarf portion 13, making it possible to secure airtightness even with a small quantity of metal In4.

Methods of manufacturing an image displaying apparatus and a television set using the airtight vessel described so far will be explained below.

FIG. 9 shows a partially cut perspective view of an image displaying apparatus using the airtight vessel according to the invention under the present application, as stated above. FIG. 10 shows the configuration of this image displaying apparatus used in a television set. A modulation drive circuit 1003 is connected by the use of a flexible cable 1001, which is a connecting wire, to the Y wirings 96 formed over the rear plate 2. The modulation drive circuit 1003 has an integrated circuit for generating modulation signals. A scanning drive circuit 1004 is connected by the use of a flexible cable 1002, which is another connecting wire, to the X wirings 95. The scanning drive circuit 1004 has an integrated circuit for generating for generating scanning signals. Television broadcast waves received by an antenna 1006 are entered into a controller 1005, video signals and timing signals are generated on the basis of the television signals, and the drive circuits 1003 and 1004 are supplied with necessary signals for them to generate modulation signals and scanning signals, respectively. By connecting this controller 1005 to the modulation drive circuit 1003 and to the scanning drive circuit 1004 by way of connectors, the television set shown in FIG. 10 can be fabricated.

This application claims priority from Japanese Patent Application Nos. 2003-364027 filed on Oct. 24, 2003, and 2004-294471 filed on Oct. 7, 2004, which are hereby incorporated by reference herein.

1. A method of manufacturing airtight vessels having:
a step of arranging a first substrate and a second substrate opposite to each other in a standing state, and
a step of bonding to one of said first substrate and said second substrate a frame for forming an airtight vessel together with said first substrate and said second substrate, wherein:
at said bonding step, a seal bonding member airtightly bonded to said frame and with one of said substrates is formed by, after successively supplying a sealing material heated to a temperature not lower than the temperature at which the bonding is possible in a state in which said first substrate and said second substrate are arranged opposite each other, solidifying the sealing material to form a seal bonding member.

2. The method of manufacturing airtight vessels according to claim 1, wherein said bonding is accomplished while vibrating said sealing material.

3. A method of manufacturing airtight vessels having:
a step of arranging a first substrate and a second substrate opposite to each other in a standing state, and
a step of bonding to one of said first substrate and said second substrate a frame for forming an airtight vessel together with said first substrate and said second substrate, wherein:
at said bonding step, a seal bonding member airtightly bonded to said frame and with one of said substrates is formed by forming the seal bonding member by solidifying a sealing material heated by local heating to a temperature not lower than the temperature at which the bonding is possible.

4. The method of manufacturing airtight vessels according to claim 3, wherein said local heating is applied to a small area at a time so that a closed bonding line to be formed by said seal bonding member be formed portion by portion.

5. The method of manufacturing airtight vessels according to claim 3, wherein irradiation with light is used for said local heating.

6. The method of manufacturing airtight vessels according to claim 1, wherein said bonding step is executed in a vacuum ambience.

7. The method of manufacturing airtight vessels according to claim 3, wherein said bonding step is executed in a vacuum ambience.

8. The method of manufacturing airtight vessels according to claim 1, wherein said sealing material is supplied to a corner composed of said frame and one of said substrates, formed by butting said frame and one of said substrates against each other.

9. The method of manufacturing airtight vessels according to claim 3, wherein said sealing material is supplied to a corner composed of said frame and one of said substrates, formed by butting said frame and one of said substrates against each other.

10. The method of manufacturing airtight vessels according to claim 3, further having a step of disposing said sealing material in a portion to be made a corner by butting said frame and one of said substrates.

11. The method of manufacturing airtight vessels according to claim 1, wherein said bonding step is a step to cause said seal bonding member to constitute a closed bonding line in a state in which said frame and the other of said substrates are butted against each other, and a section of said seal bonding member cut in a prescribed position on said bonding line in a direction orthogonal to the lengthwise direction of the bonding line has a shape in which the length of contact with said frame is longer than the length of penetration between the opposite faces of said substrate and said frame in the corner composed of said substrate and said frame by said butting.

12. The method of manufacturing airtight vessels according to claim 3, wherein said bonding step is a step to cause said seal bonding member to constitute a closed bonding line in a state in which said frame and the other of said substrates are butted against each other, and a section of said seal bonding member cut in a prescribed position on said bonding line in a direction orthogonal to the lengthwise direction of the bonding line has a shape in which the length of contact with said frame is longer than the length of penetration between the opposite faces of said substrate and said frame in the corner composed of said substrate and said frame by said butting.

13. A method of manufacturing image displaying apparatuses wherein an airtight vessel containing a display device is fabricated by the method according to claim 1.

14. A method of manufacturing image displaying apparatuses wherein an airtight vessel containing a display device is fabricated by the method according to claim 3.

15. A method of manufacturing television sets having a step of connecting an airtight vessel fabricated by the method of manufacturing according to claim 1 and a drive circuit for applying a voltage to display electrodes within the airtight vessel and a step of arranging a controller for displaying television images.

16. A method of manufacturing television sets having a step of connecting an airtight vessel fabricated by the method of manufacturing according to claim 3 and a drive circuit for applying a voltage to display electrodes within the airtight vessel and a step of arranging a controller for displaying television images.
